(19) United States
(12) Patent Application Publication
(10) Pub. No.: US 2007/0147333 A1
(43) Pub. Date: Jun. 28, 2007

(54) System and method of transmission scheduling in time-division duplex communication system to minimize interference

(76) Inventor: Mahesh A. Makhijani, San Diego, CA (US)

Correspondence Address: COATS & BENNETT, PLLC, 1400 Crescent Green, Suite 300, Cary, NC, 27518, US

(21) Appl. No.: 11/316,030

(22) Filed: Dec. 22, 2005

(51) Int. Cl. H04Q 7/24

(52) U.S. Cl. 370/347; 370/338

(57) ABSTRACT

In a Time-Division Duplex (TDD) data frame, wherein time slots are allocated to downlink and uplink transmissions, time slots are allocated to pending communication signals beginning at the start of the data frame for one of downlink and uplink transmissions, and are allocated to pending communication signals beginning at the end of the frame for the other of downlink and uplink transmissions. When one or more time slots allocated to downlink and/or uplink transmissions are not utilized for actual communication signal transmission, the non-utilized time slot(s) occur towards the middle of the TDD data frame rather than at the end. This reduces the probability of base station/subscriber terminal interference with another sector or cell utilizing a different downlink/uplink time slot allocation.

### BACKGROUND

The present invention relates generally to the field of wireless communications and in particular to a system and method of scheduling users in a Time-Division Duplex system that minimizes base station/subscriber terminal interference.

Wireless communications systems are well known in the art. Most deployed wireless communications systems utilize Frequency-Domain Duplexing (FDD), whereby downlink signals (i.e., signals transmitted from a base station to a mobile station) are transmitted in a different frequency band than are uplink signals (those from a mobile station to a base station). While this simplifies many duplex issues, it is expensive in terms of spectrum requirements and transceiver complexity.

The Worldwide Interoperability for Microwave Access, or WiMAX, is a metropolitan area networking protocol with promise for the delivery of Broadband Wireless Access (BWA), backhaul for Wi-Fi hotspots, and backhaul for wireless cellular communication system base stations, among other applications. WiMAX is based on the IEEE 802.16 standard, which addresses Line-of Sight (LOS) environments in the 10-66 GHz range, with channel bandwidths of 20, 25, and 28 MHz, and bit rates of 32 to 134 Mb/sec. IEEE 802.16 compliant systems are envisioned for deployment in the licensed spectrum. WiMAX systems transmit communication signals between a base station and one or more subscriber terminals, which may be fixed or mobile, within the region, or cell, served by the WiMAX base station. WiMAX cells may be sectorized, as well known in the wireless communication arts.

Another WiMAX embodiment, based on the IEEE 802.16-2004/16e standard, addresses Non-Line-of-Sight (NLOS) environments in the 2-11 GHz range, with selectable channel bandwidths between 1.25 and 20 MHz, with up to 60 logical sub-channels (at 20 MHz channelization), supporting bit rates up to 75 Mb/sec. The channelization flexibility allows 802.16-2004/16e WiMAX systems to be deployed in both licensed and license-exempt spectra, and additionally to take advantage of varying spectrum availability worldwide. Another important part of spectrum flexibility in WiMAX is the ability to implement duplexing in either time or frequency.

Most deployed wireless cellular communications systems employ Frequency-Domain Duplex (FDD), wherein uplink and downlink signals are transmitted in different frequency bands. This provides the advantages of simultaneous uplink/downlink transmissions, and the use of different channelization and modulation schemes in the different directions (particularly advantageous where the traffic is asymmetrically distributed). The primary disadvantage of FDD duplexing is that it requires greater spectrum allocation.

Time-Domain Duplex (TDD), utilized in most wired communication systems, is a form of Time-Division Multiple Access (TDMA) protocol. In TDMA systems, a data frame is defined, and divided into a plurality of time slots. Separate communication signals are divided into short snippets, and a snippet of each signal is assigned to a time slot in the data frame. During each successive data frame, successive portions of each communication signal are transmitted within one or more time slots allocated to that signal. Each TDMA time slot position comprises a logical channel, which may be allocated to any communication signal. In TDD, one or more time slots are allocated to one or more communication signals in one direction (e.g., uplink or downlink), and one or more time slots are allocated to communication signals in the other direction. Within a given closed system or portion thereof (e.g., cell or sector), the allocation of each time slot to either a downlink or uplink signal—but not both simultaneously—means that transmitting subscriber terminals may experience interference from other subscriber terminals in the cell or sector, but not also from the base station.

TDD requires less spectrum allocation then FDD. One disadvantage of TDD is that, unless the allocation of time slots to uplink and downlink transmissions is coordinated between cells or sectors, some subscriber terminals (such as those near cell or sector boundaries) may simultaneously experience interference from both base station and other subscriber terminal transmissions. In a code-channelized system, such as Code Division Multiple Access (CDMA) cellular systems, or Coded Orthogonal Frequency Division Multiplexing (COFDM), which is used in WiMAX, interference from other system users is seen at each subscriber terminal as noise. Thus, increased interference raises the noise floor for each receiver, reducing the Signal to Noise Ratio (SNR), and requiring increased transmission power for effective communication. Since base station signals are transmitted at a much higher power level than are subscriber terminal signals, downlink transmissions in one cell or sector may swamp uplink transmissions in the same time slot in parts of an adjacent cell or sector, exceeding the power capacity of the subscriber terminal and requiring re-transmissions.

FIG. 1 depicts a TDD allocation of time slots between downlink and uplink transmissions for two different sectors of a wireless communication system cell, wherein schedulers independently allocate time slots for data frames in the different sectors (e.g., based on the relative traffic load in each direction). In sector A, the first five time slots in each data frame are allocated to downlink transmissions, and to the last three time slots are allocated to uplink transmissions (in WBA applications, traffic load is typically asymmetrical, with much higher traffic volume in the downlink direction). In the example depicted, downlink signals fill all five allocated downlink time slots; however, only two time slots allocated to uplink transmissions are actually utilized by subscriber terminals within sector A. The uplink signals are assigned by the scheduler to time slots beginning at the first time slot allocated to uplink transmissions (i.e., slot 5), and “fill” towards the end of the TDD data frame.

In sector B, the first six time slots are allocated to downlink transmissions, and the last two time slots are allocated to uplink transmissions. In this example, all time slots in both directions are utilized. Due to the lack of synchronization between sectors A and B in time slot allocation between downlink and uplink transmissions, in time slot 5, the base station is transmitting a signal to one or more subscriber terminals in sector B at the same time that a subscriber terminal in sector A is transmitting a signal to the base station. Due to the much higher power level of base station transmissions, the subscriber terminal in sector A that is transmitting during timeslot 5 may experience such a high level of interference that is unable to increase its transmit power sufficiently to overcome the interference. Those of skill in the art will recognize that the same interference situation may arise due to uncoordinated TDD timeslot allocations between different cells.

### SUMMARY

In a TDD data frame, wherein time slots are allocated to downlink and uplink transmissions, time slots are allocated to pending communication signals beginning at the start of the data frame for one of downlink and uplink transmissions, and are allocated to pending communication signals beginning at the end of the frame for the other of downlink and uplink transmissions. When one or more time slots allocated to downlink and/or uplink transmissions are not utilized for actual communication signal transmission, the non-utilized time slot(s) occur towards the middle of the TDD data frame rather than at the end. This reduces the probability of base station/subscriber terminal interference with another sector or cell utilizing a different allocation of TDD data frame time slots to downlink and uplink transmissions.

In one embodiment, the present invention relates to a method of scheduling uplink and downlink transmissions in a time-division duplex wireless communication system. A time-division data frame having two or more time slots to be allocated to either uplink or downlink transmissions is defined. Time slots are allocated beginning at the start of the frame to one of uplink or downlink transmissions, and are allocated beginning at the end of the frame to the other of uplink or downlink transmissions.

In another embodiment, the present invention relates to a base station in a time-division duplex wireless communication system. For one more sectors, the base station includes a radio frequency transceiver operative to transmit downlink signals to, and to receive uplink signals from, one or more mobile terminals, and a scheduler operative to allocate time slots in a time-division data frame to uplink and downlink transmissions, the scheduler allocating one of uplink or downlink transmissions from the start of each frame, and allocating the other of uplink or downlink transmissions from the end of each frame.

In another embodiment, the present invention relates to a method of minimizing base station/subscriber terminal interference in a time-division duplex wireless communication system. Downlink transmissions from base stations to subscriber terminals are scheduled beginning at the start of a time-division frame. Uplink transmissions from subscriber terminals to base stations are scheduled beginning at the end of the time-division frame. Downlink transmissions scheduled in intermediate time slots of the time-division frame experience minimal base station/subscriber terminal interference between sectors or cells when the number of downlink transmissions dominates the number of uplink transmissions

### BRIEF DESCRIPTION OF DRAWINGS

FIG. 1 is a diagram of a prior art TDD data frame time slot allocation.

FIG. 2 is a diagram of a wireless communication system sectorized cell.

FIG. 3 is a diagram of a TDD data frame time slot allocation.

FIG. 4 is a flow diagram of a method of scheduling transmissions in a TDD data frame.

### DETAILED DESCRIPTION

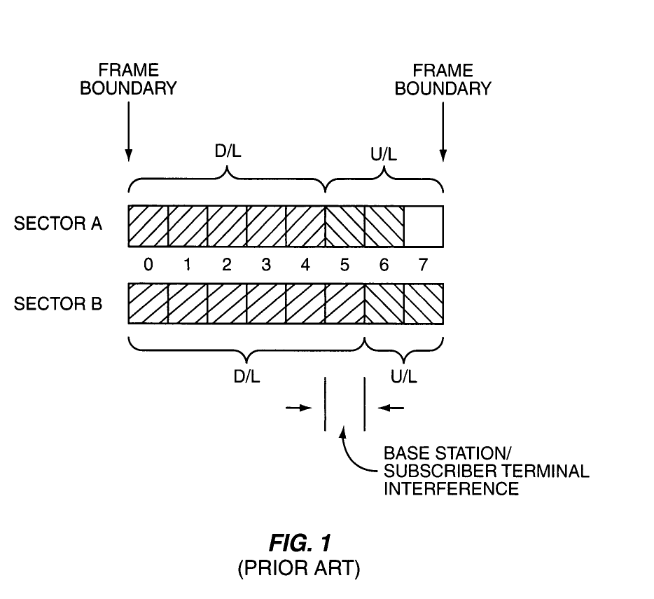

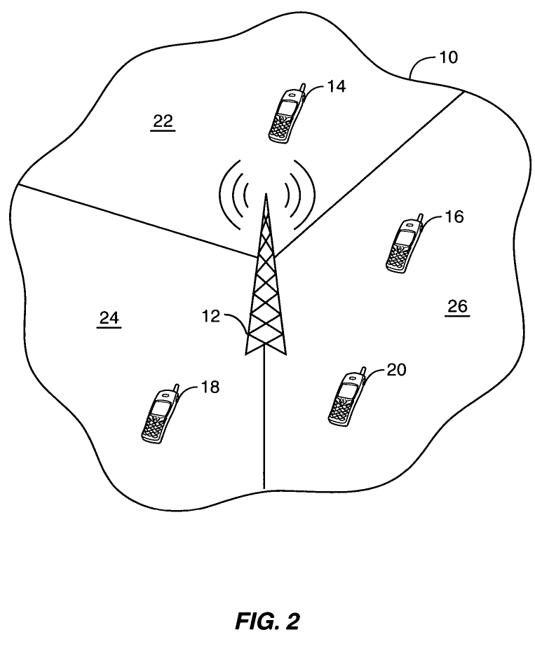

FIG. 2 depicts a cell 10 of a wireless communication system utilizing TDD. Radio Frequency (RF) communication signals are transmitted between a base station 12 and representative subscriber terminals 14, 16, 18, 20. As well known in the art, the cell 10 may be divided into sectors 22, 24, 26. TDD data frame time slots are independently allocated between downlink and uplink transmissions in each sector 22, 24, 26. Subscriber terminals positioned proximate a cell boundary, such as 14 and 16, may experience base station/subscriber terminal interference if uplink and downlink transmissions are scheduled in the same time slot, as depicted in FIG. 1. Those of skill in the art will recognize that a similar base station/subscriber terminal interference situation may arise between subscriber terminals 14, 16, 18, 20 and the base station of a neighboring cell (not shown).

According to one or more embodiments of the present invention, the probability of base station/subscriber terminal interference is reduced by allocating time slots to downlink and uplink transmissions beginning at opposite ends of the TDD data frame. For example, time slots may be allocated to downlink transmissions beginning at the start of the TDD data frame, and time slots may be allocated to uplink transmissions beginning at the end of the TDD data frame.

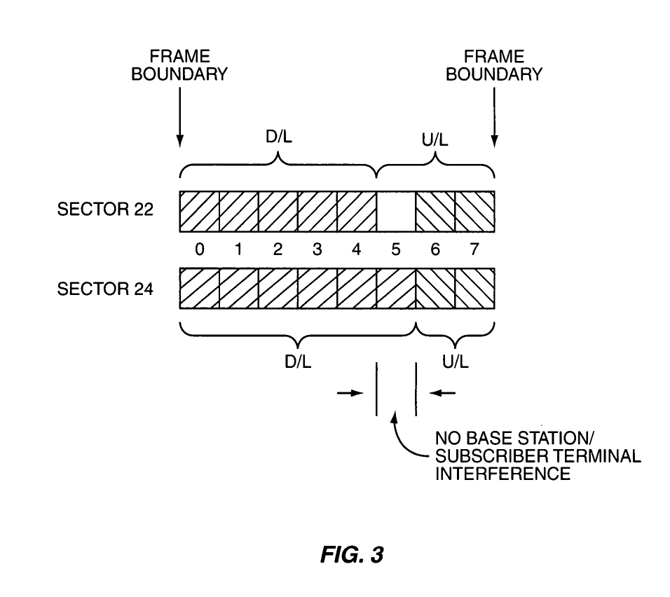

FIG. 3 depicts how of this method of time slot allocation may reduce base station/subscriber terminal interference. In FIG. 3, the TDD data frame is divided between downlink and uplink transmissions for sector 22 in the same manner as that depicted in FIG. 1 for sector A. That is, time slots 0-4 are allocated to downlink transmissions, and time slots 5-7 are allocated to uplink transmissions. However, the scheduler fills the time slots with pending communication signals beginning from the ends of the TDD data frame, rather than from the start of the respective allocated block. As depicted in FIG. 3, all five time slots allocated to downlink transmissions are utilized. Only two of the three time slots allocated to uplink transmissions are utilized. According to the present invention, the uplink communication signals are scheduled beginning at the end of the TDD data frame—that is, beginning with timeslot 7—and “fill” towards the middle of the TDD data frame. This scheduling algorithm positions unused uplink time slots in the middle of the TDD data frame, rather than at the end.

The TDD data frame of sector 24 is divided into six downlink transmission time slots and two uplink transmission time slots. All of the allocated time slots are utilized for communication signal transmission. Because sector 22 allocated time slots to uplink transmissions beginning at the end of its TDD data frame, the downlink transmissions at sector 24 during timeslot 5 do not interfere with any uplink transmissions at sector 22 during the same time slot, thus avoiding base station/subscriber terminal interference. Note that while the example of FIG. 3 depicts downlink transmissions scheduled from the beginning of a TDD data frame and uplink transmissions scheduled from the end of the TDD data frame, the reverse scheduling would achieve the same interference reduction benefit. That is, uplink transmissions may be scheduled beginning at the start of a TDD data frame, with downlink transmissions scheduled beginning at the end of the TDD data frame.

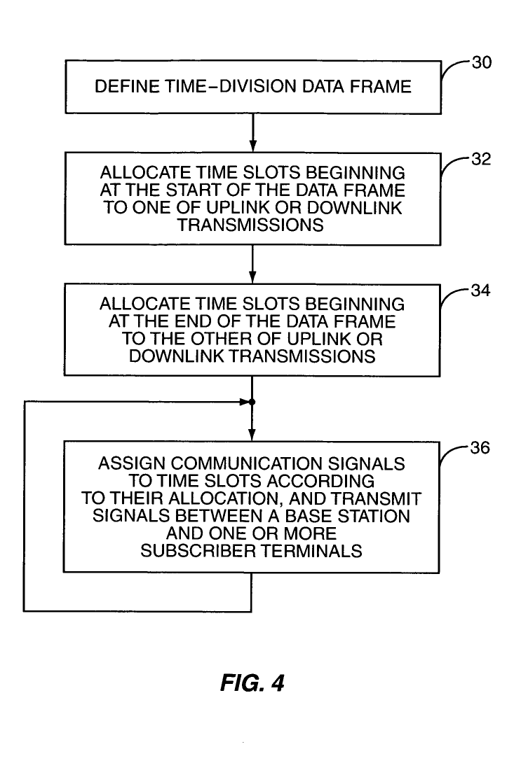

A method of scheduling downlink and uplink transmissions in a TDD wireless communication system is depicted in flow diagram form in FIG. 4. A scheduler defines a time-division data frame (block 30), and allocates time slots to one of uplink or downlink transmissions beginning at the start of the data frame (block 32). The scheduler then allocates time slots to the other of uplink or downlink transmissions beginning at the end of the data frame (block 34). The scheduler then assigns communication signals to time slots according to this time slot allocation, and transmits signals between the base station and one or more subscriber terminals (block 36). The assignment of communication signals to successive TDD data frames according to this allocation of time slots continues, as indicated by the arrow looping around block 36.

As a result of transmitting the communication signals according to this allocation in the TDD data frame, the probability of base station/subscriber terminal interference between sectors or cells is reduced. This results in lower power transmissions for subscriber terminals (an important consideration for battery-operated mobile terminals), reduced system interference, and fewer re-transmissions, allowing for higher throughput and more efficient use of communication system resources. The reduced probability of base station/subscriber terminal interference achieved by the TDD data frame time slot scheduling algorithm of the present invention makes TDD a more attractive option than FDD, which enhances the spectrum flexibility of wireless communication systems such as WiMAX.

In addition to interference reduction, this TDD scheduling according to the present invention also provides additional time for the subscriber terminal to switch transmission modes, i.e. from Rx to Tx, where the uplink signals are allocated from the end of the frame. This reduces the time needed for a Transmit Time Guard (TTG). In addition, since a WiMAX base station has some knowledge of the distance to the subscriber terminal due to ranging, the base station may schedule users furthest away at the at the end of the frame.

Although the system and method of TDD scheduling according to the present invention is described herein with respect to WiMAX and COFDM, it is not limited to such. The present invention may be advantageously applied, for example, in any TDD system that includes Time Division Synchronous Code Division Multiple Access (TD-SCDMA) or Time Division Duplex Universal Mobile Telecommunications System (TDD-UMTS) systems.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of scheduling uplink and downlink transmissions in a time-division duplex wireless communication system, comprising:
defining a time-division data frame having two or more time slots to be allocated to either uplink or downlink transmissions;
allocating time slots beginning at the start of the frame to one of uplink or downlink transmissions; and
allocating time slots beginning at the end of the frame to the other of uplink or downlink transmissions.

2. The method of claim 1 wherein downlink transmissions are allocated from the start of the frame and uplink transmissions are allocated from the end of the frame.

3. The method of claim 2, further comprising:
estimating the distances from a base station to two or more subscriber terminals; and
scheduling uplink transmissions for the further subscriber terminal closer to the end of the frame than uplink transmissions for the closer subscriber terminal.

4. The method of claim 3 further comprising reducing the transmit time guard separating receive and transmit modes in the subscriber terminals.

5. The method of claim 1 wherein time slot allocations are performed independently for each sector in a cell.

6. The method of claim 1 wherein time slot allocations are performed independently for each cell in the system.

7. The method of claim 1 wherein the transmissions are Orthogonal Frequency Division Multiplexed.

8. The method of claim 1 wherein the transmissions conform to one of the IEEE 802.16x wireless communication protocols.

9. The method of claim 1 wherein the transmissions conform to the TD-SCDMA protocol.

10. The method of claim 1 wherein the transmissions conform to the TDD-UMTS protocol.

11. A base station in a time-division duplex wireless communication system, comprising, for one or more sectors:
a radio frequency transceiver operative to transmit downlink signals to, and to receive uplink signals from, one or more mobile terminals; and
a scheduler operative to allocate time slots in a time-division data frame to uplink and downlink transmissions, the scheduler allocating one of uplink or downlink transmissions from the start of each frame, and allocating the other of uplink or downlink transmissions from the end of each frame.

12. The base station of claim 11 wherein the scheduler allocates downlink transmissions from the start of the frame and allocates uplink transmissions from the end of the frame.

13. The base station of claim 12, further comprising:
a ranging module operative to estimate the distances from the base station to two or more subscriber terminals; and
wherein the scheduler allocates uplink transmissions for the further subscriber terminal closer to the end of the frame than uplink transmissions for the closer subscriber terminal.

14. The base station of claim 11 wherein the scheduler is operative to independently allocate time slots to uplink and downlink transmission in each sector.

15. The base station of claim 11 wherein the scheduler is operative to allocate time slots to uplink and downlink transmission independently of any other base station scheduler operation.

16. The base station of claim 11 wherein the transceiver transmits and receives Orthogonal Frequency Division Multiplexed signals.

17. The base station of claim 11 wherein the uplink and downlink signals conform to one of the IEEE 802.16x wireless communication protocols.

18. The base station of claim 11 wherein the uplink and downlink signals conform to the TD-SCDMA protocol.

19. The base station of claim 11 wherein the uplink and downlink signals conform to the TDD-UMTA protocol.

20. A method of minimizing base station/subscriber terminal interference in a time-division duplex wireless communication system, comprising:
scheduling downlink transmissions from base stations to subscriber terminals beginning at the start of a time-division frame; and
scheduling uplink transmissions from subscriber terminals to base stations beginning at the end of the time-division frame;
whereby downlink transmissions scheduled in intermediate time slots of the time-division frame avoid base station/subscriber terminal interference between sectors or cells when the number of downlink transmissions dominates the number of uplink transmissions.

21. The method of claim 20 further comprising:
estimating the distance from the base station to two or more subscriber terminals, and
scheduling uplink transmissions for the further subscriber terminal closer to the end of the frame than uplink transmissions for the closer subscriber terminal.

22. The method of claim 21 further comprising reducing the transmit time guard separating receive and transmit modes in the subscriber terminals.

23. The method of claim 20 wherein time slot allocations are performed independently for each sector in a cell.

24. The method of claim 20 wherein time slot allocations are performed independently for each cell in the system.

25. The method of claim 20 wherein the transmissions are Orthogonal Frequency Division Multiplexed.

26. The method of claim 20 wherein the transmissions conform to one of the IEEE 802.16x wireless communication protocols.

27. The method of claim 20 wherein the transmissions conform to the TD-SCDMA protocol.

28. The method of claim 20 wherein the transmissions conform to the TDD-UMTA protocol.
